(19) United States
(12) Patent Application Publication
(10) Pub. No.: US 2023/0131774 A1
(43) Pub. Date: Apr. 27, 2023

(54) HIGH VOLTAGE CENTER BREAK DISCONNECT SWITCH WITH TOGGLE DRIVE LOCKING MECHANISM

(71) Applicant: CLEAVELAND/PRICE INC., TRAFFORD, PA (US)

(72) Inventor: ROBERT J. ROSS, TRAFFORD, PA (US)

(73) Assignee: CLEAVELAND/PRICE INC., TRAFFORD, PA (US)

(21) Appl. No.: 17/860,299

(22) Filed: Jul. 8, 2022

Related U.S. Application Data
(60) Provisional application No. 63/271,766, filed on Oct. 26, 2021.

(51) Int. Cl. H01H 33/12

(52) U.S. Cl. CPC H01H 33/124; H01H 33/128

(57) ABSTRACT

A high voltage center break disconnect switch with two rotatable switch blades each operatively attached to a respective rotatable insulator for opening and closing the switch. A toggle locking drive assembly including a two-sided lever having three pivot points colinearly aligned thereon and two drive links each connected at one end thereof to one of the three pivot points. The two-sided lever connects at the third pivot point to a perpendicularly attached rotating shaft operatively connected to a drive pipe for opening and closing the switch. The drive links are each connected at the other end to a pivot point of a respective one of two levers each operatively mounted to one of the rotatable insulators. When the switch is in the closed position the five pivot points of the locking toggle drive assembly are aligned colinearly in a toggle lock position preventing the switch from unintended opening.

### CROSS-REFERENCE TO RELATED APPLICATION

This application claims the benefit of U.S. Provisional Patent Application No. 63/271,766 filed Oct. 26, 2021, which is incorporated herein by reference in its entirety.

### BACKGROUND OF THE INVENTION

The invention relates generally to a center break disconnect switch for high voltage applications and, more particularly, to the drive mechanism of such a high voltage center break disconnect switch.

In electric power systems, high voltage disconnect switches are employed to isolate transmission lines and high voltage electrical apparatus to permit the inspection or repair of such apparatus or redirect power or other reasons. A common outdoor center break disconnect switch drive mechanism includes two oppositely disposed rotatable post insulators. The rotatable insulators are transversely mounted to the top of an elongated base member proximate opposite ends of the base member. A current carrying switch blade is fixedly mounted to the top of each insulator extending parallel to the elongated base member. When the center break switch is opened, the two rotatable post insulators each rotate through an angle of about 90 degrees about their respective longitudinal axes in opposite directions. Each attached current carrying switch blade thus rotates the same angular distance with respect to the longitudinal axis of the respective insulator.

The prior art common center break disconnect normally has a single link, typically a pipe, that connects to two opposing levers. Each lever is operatively attached to the bottom of a respective one of the two rotatable post insulators. The two levers extend on opposite sides with respect to the elongated base member in the switch closed position as shown in FIG. 1 with the open position shown in dash line configuration. Such a prior art common center break switch is currently sold by Cleaveland/Price Inc., the present assignee. An example of such a prior art Cleaveland/Price Inc. center break switch can be found by reference to Cleaveland/Price Inc. Bulletin DB-126618, entitled “Aluminum Center Break Switch—Switch Types CB-A, CB-AV, 69 KV-230 kV, 1200 A-3000 A”, which is incorporated herein by reference as though fully set forth.

Such a prior art common center break disconnect switch is operated by a drive pipe operatively connected to a drive pipe lever which is also attached to the first insulator and to the first of the opposing levers. When the drive pipe is advanced to open or close the switch, it causes the drive pipe lever and the first of the opposing levers, to rotate, which in turn causes the single link between the two rotatable insulators to move and force the second opposing lever to also rotate which imparts a rotation to the second rotatable insulator in an opposite direction from the first rotatable insulator to open or close the switch by moving the switch blades, as shown in FIG. 1.

It is known in the electrical utility industry that problems may arise with such a common prior art center break switch drive mechanism due to seismic or short circuit magnetic forces that may translate very high forces back to the drive pipe and also to the interphase pipes between the three switches, in the case of a three phase electrical switch arrangement—not shown in the drawings, which causes the two switch blades of each switch, in the closed electrically conductive position to partially open, resulting in the switch contacts of the two switch blades to arc and cause burn damage. It has been found that this unintended opening problem of such a prior art center break switch is especially prevalent for prior art high voltage center break switches. High voltage center break switches are typically rated for handling voltages from 115 kV to 500 kV. Such high voltage rated center break switches have longer and heavier blades that impart a greater force to open the switch. It has been found that the present prior art center break switch mechanical linkage is too flexible and is unable to hold the switch closed due to these high forces which can be applied to all three phases, in the case of a three phase switch installation.

It is therefore an object of the present invention to provide an improved center break switch with a center break switch drive mechanism which prevents the two switch blades in the closed electrically conductive position from opening due to seismic or short circuit magnetic forces.

### SUMMARY OF THE INVENTION

The object is achieved by the high voltage center break disconnect switch of the present invention which is provided with an improved drive mechanism for preventing the switch blades in the closed electrically conductive position from partially opening unintentionally. This is accomplished by the toggle drive locking mechanism of the present invention which is applied to each switch of the three phases.

The toggle drive locking mechanism of the present invention, includes a rotating shaft member supported by upper and lower bearing brackets attached to the switch elongated longitudinal base member. In one embodiment the elongated longitudinal base member can be an elongated box beam having a bottom and top surface. The rotating shaft member is supported by the bearing brackets attached to the top and bottom bearing surfaces as shown in FIGS. 2 and 3. The top bracket having a first bearing aperture for receiving the rotating shaft member. The bottom bracket having a second bearing aperture for receiving the rotating shaft member.

The rotating shaft member is positioned equidistant between the two rotating insulators and offset to one side of the base member as can be seen in FIGS. 2 and 3.

A two-sided lever having three pivot points or axes is provided. The two-sided lever having a center pivot point and two oppositely disposed outer pivot points. The two-sided lever is fixedly mounted to the top of the rotating shaft member as shown in FIGS. 2 and 3 at the center pivot point, which is the center of rotation of the two-sided lever. The center pivot point and the two outer pivot points aligned colinearly.

Each of two oppositely disposed drive links are respectively attached at a first end thereof proximate one of the two outer pivot points of the two-sided lever as shown in FIGS. 2 and 3. The two oppositely disposed drive links are attached respectively at a second end thereof to two rotatable insulator levers mounted to the bottom of the respective rotatable insulator as shown in FIGS. 2 and 3.

A drive pipe lever is attached to the rotating shaft member near the bottom of the rotating shaft member. The drive pipe lever can be pulled by a drive pipe or interphase pipe a predetermined angular distance in one direction to lock the switch closed or pushed in an opposite direction to open the switch to the open position as shown in FIG. 3. The two-sided lever allows the two oppositely disposed drive links to go into toggle, i.e., locking position, in the closed position of the center break switch to lock the switch from opening. This lock position keeps the switch closed against seismic and magnetic forces that may be exerted to open the switch.

The rotatable insulator levers mounted at the bottom of the rotatable insulators are not mounted opposed, i.e., on opposite sides of the elongated base member, as shown in FIG. 1 and previously mentioned Cleaveland/Price Inc. Bulletin DB-126618, but instead are mounted on the same side of the elongated base member. This arrangement is necessary to lock the center break switch in the closed position, as shown in FIG. 2. To operate the switch open, the drive pipe lever rotates the rotating shaft member and causes the two-sided lever and the two rotatable insulator levers to rotate and come out of the locked toggle position causing the switch to open as shown in FIG. 3. When operating the switch to the open position the drive pipe is pushed which turns the rotating shaft and the two-sided lever and the two rotatable insulator levers.

These and other aspects of the present invention will be further understood from the entirety of the description, drawings and claims.

### BRIEF DESCRIPTION OF THE DRAWINGS

For a better understanding of the invention reference may be made to the accompanying drawings exemplary of the invention, in which:

FIG. 1 is a perspective view of a prior art high voltage center break switch;

FIG. 2 is a perspective view of the high voltage center break switch of the present invention in the electrically closed position; and,

FIG. 3 is a perspective view of the high voltage center break switch of the present invention in the electrically open position.

### DETAILED DESCRIPTION OF THE INVENTION

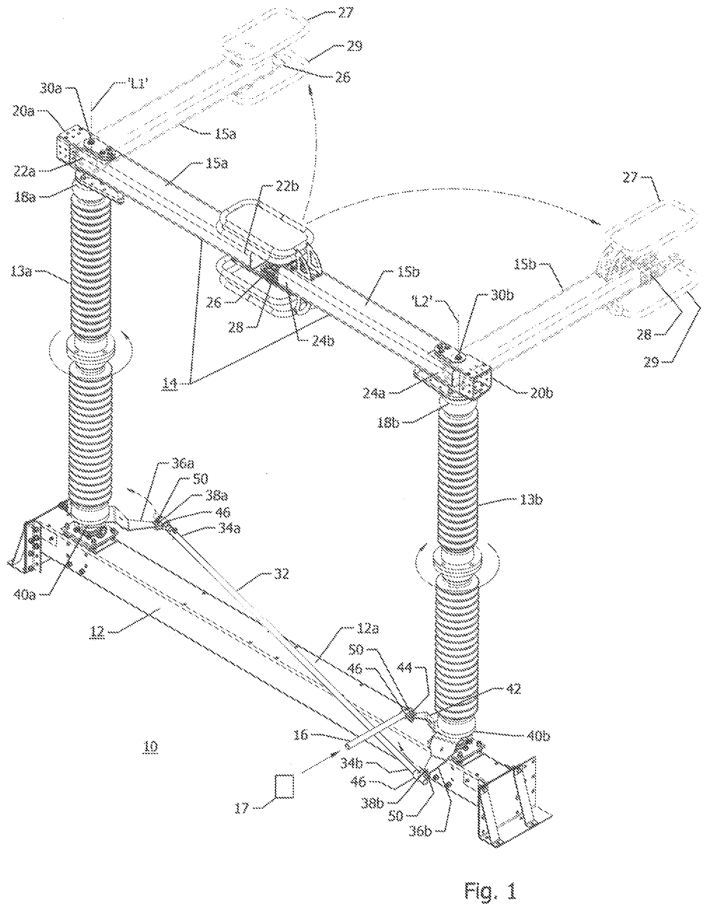

With reference to FIG. 1 showing the prior art, a high voltage center break disconnect switch 10 in the electrically closed position and also in the electrically opened position, indicated by the curved arrows with dashed lines, is shown. The switch 10 includes an elongated longitudinal base member or beam 12 having a top surface 12a with two perpendicularly mounted post-type rotatable cylindrically-shaped insulators 13a and 13b operatively attached thereto. The switch 10 includes a switch blade assembly 14 including two oppositely disposed rotatable switch blades 15a, 15b respectively operatively mounted proximate the tops 18a, 18b of the rotatable insulators 13a, 13b. The post-type rotatable insulators 13a, 13b are rotatable and can be driven by a prime mover 17, indicated by a rectangular box, such as an electric motor with controls or a manual geared hand crank assembly having a prime mover drive shaft, as well known in the art. The prime mover 17 when required causes the drive pipe 16 to exert force to rotate the rotatable insulators 13a, 13b to open and close the switch 10.

A first line-terminal stationary connection 20a is supported by the top 18a of the first post-type rotatable cylindrically-shaped insulator 13a. A second line-terminal stationary connection 20b is supported by the top 18b of the second post-type rotatable cylindrically-shaped insulator 13b. The first rotatable switch blade 15a at its proximal end 22a is in operative electrical circuit relationship with the first line terminal stationary connection 20a connecting to a power line, not shown in the drawings. The second rotatable switch blade 15b at its proximal end 24a is in operative electrical circuit relationship with the second line terminal stationary connection 20b connecting to a power line, not shown in the drawings. The first rotatable switch blade 15a at its distal end 22b includes a blade tip 26, as can be seen in the open dashed line position. The second rotatable switch blade 15b at its distal end 24b includes a break-jaw contact assembly 28, as can be seen in the open dashed line position. The switch blade tip 26 for contacting the break-jaw contact assembly 28, when the switch 10 is in the electrically closed position, is shown in FIG. 1. The elongated switch blades 15a, 15b are pivotally mounted at their respective proximal end 22a, 24a to respective first and second pivot hinge assemblies 30a, 30b, which are each mounted to the respective tops 18a, 18b of the rotatable insulators 13a, 13b for electrically opening and closing the switch blades 15a, 15b of the high voltage center break disconnect switch 10. The general details of this arrangement are apparent by reference to FIG. 1. The elongated switch blades 15a, 15b may be square tubular, for example. The high voltage break disconnect switch 10 may also include ice shields 27 and corona rings 29 as shown in FIG. 1.

As shown in FIG. 1, the two rotatable post-type perpendicular cylindrically-shaped insulators 13a, 13b are capable of pivotal operative motion about their respective longitudinal axes ‘L1’, ‘L2’, as shown by the respective arrows for driving open the switch blades 15a, 15b.

As shown in FIG. 1, the prior art arrangement for mechanically interconnecting the operation of the switch blades 15a, 15b includes a single link 32 having a cylindrical cross-section operatively attached by clamp brackets 46 at opposite ends 34a, 34b of the single link 32 to respective connection pivot points 38a, 38b of respective levers 36a, 36b. The respective levers 36a, 36b are operatively mounted proximate the bottom 40a, 40b of the respective post-type cylindrically shaped insulator 13a, 13b and extend on opposite sides of the elongated base member 12 in the switch closed position, as shown in FIG. 1. Also, a drive pipe lever 42 is operatively mounted at the bottom 40b of the second post-type cylindrically shaped insulator 13b. The drive pipe 16 is operatively connected to a drive pipe lever connection pivot point 44 of the drive pipe lever 42. The single link 32 has two clamp brackets 46 operatively attached. The drive pipe 16 has one clamp bracket 46 operatively attached. Each clamp bracket 46 includes apertures that align with an aperture in the respective levers 36a, 36b, and 42, not shown in detail in the drawings, for receiving a pivot bolt 50 as the connection pivot point which may engage a nut, not shown in the drawings, for securing the single link 32 and the drive pipe 16. When the drive pipe 16 is advanced to open the switch 10, it causes the drive pipe lever 42 to rotate insulator 13b, which in turn causes second lever 36b and single link 32 connected between the two post-type cylindrically shaped insulators 13a, 13b to rotate insulator 13a via first lever 36a as shown in FIG. 1 to rotate the insulators in opposite directions. This rotation to open the center break switch 10 causes the first switch blade 15a and the second switch blade 15b to rotate to a predetermined angle, such as 90 degrees as shown in FIG. 1, to the electrically open non-conductive position. The drive pipe 16 is moved in a reverse manner to electrically close the switch 10.

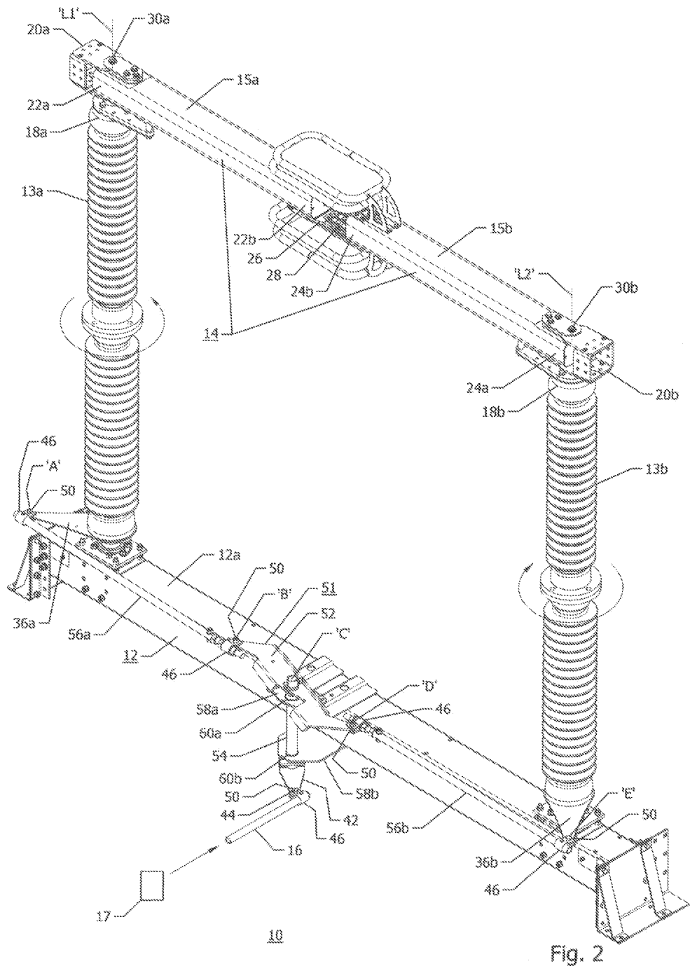

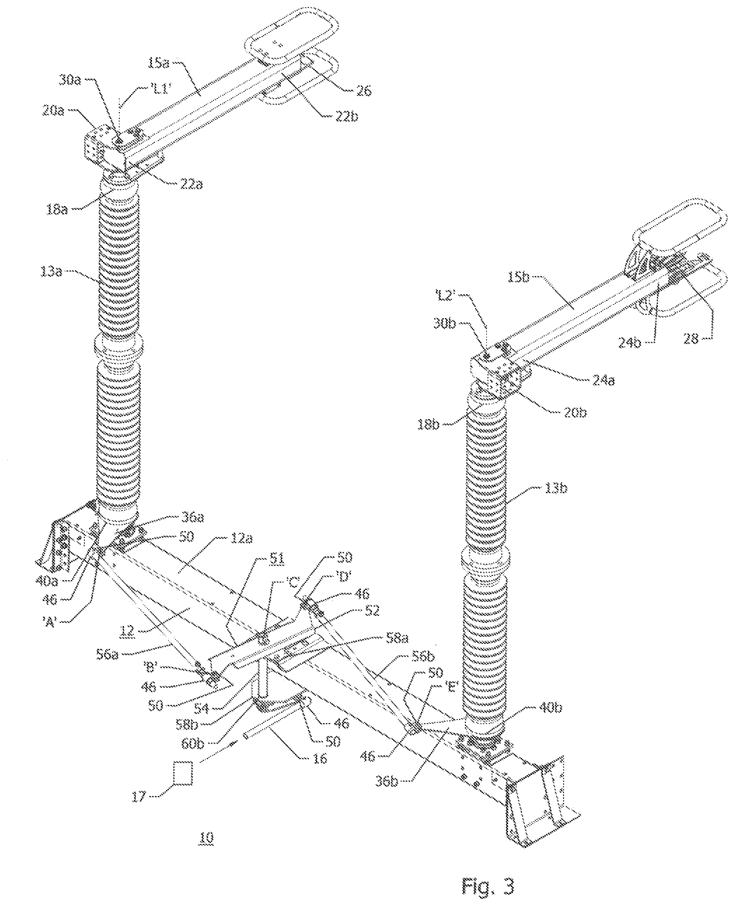

With reference to FIGS. 2 and 3, the center break disconnect switch with a toggle locking drive mechanism 51 of the present invention is shown which eliminates the unintended opening problem mentioned with the prior art center break disconnect switch. Like numerals are used in FIGS. 2 and 3 as described for FIG. 1 for the prior art center break switch for like parts. The blade components of the center break disconnect switch 10 as shown in FIGS. 2 and 3 attached to the top 18a of the first post-type rotatable cylindrically shaped insulator 13a and the top 18b of the second post-type rotatable cylindrically shaped insulator 13b are the same and have the same function as already described for the prior art center break switch depicted in FIG. 1. The toggle locking drive mechanism 51 of this embodiment of the present invention includes a two-sided lever 52, drive links 56a, 56b, clamp brackets 46, pivot bolts 50 and first and second levers 36a, 36b. FIG. 2 shows first lever 36a connected to drive link 56a by one of the clamp brackets 46 and a pivot bolt 50 passing through apertures in the clamp bracket 46 and the first lever 36a, the apertures not shown, at a first pivot point ‘A’. Drive link 56a is also connected to the two-sided lever 52 by another of the clamp brackets 46 and a pivot bolt 50 passing through apertures in the clamp bracket 46 and the two-sided lever 52, the apertures not shown, at a second pivot point ‘B’. Drive link 56b is connected to lever 36b by another of the clamp brackets 46 and a pivot bolt 50 passing through apertures in the clamp bracket 46 and the lever 36b, the apertures not shown, at a fifth pivot point ‘E’. Drive link 56b is also connected to the two-sided lever 52 by another of the clamp brackets 46 and a pivot bolt 50 passing through apertures in the clamp bracket 46 and the two-sided lever 52, the apertures not shown, at a fourth pivot point ‘D’. The first and second levers 36a and 36b are rotatably mounted under the respective insulator 13a, 13b on the same side of the elongated base member 12 in the switch electrically closed position as shown in FIG. 2. This arrangement is necessary to have the insulators rotate in opposing directions as the center break switch operates as shown in FIG. 3.

The two-sided lever 52 is mounted near the top of a rotating shaft member pivot 54 by welding, for example. The rotating shaft member pivot 54 with the attached two-sided lever 52 is supported by an upper bracket 58a and a lower bracket 58b attached to the elongated longitudinal base member or beam 12 as shown in FIGS. 2 and 3. An upper bearing 60a operatively supports the rotating shaft member pivot 54 in the upper bracket 58a and a lower bearing 60b operatively supports the rotating shaft member 54 in the lower bracket 58b. The upper bearing 60a and the lower bearing 60b may be chlorinated polyvinyl chloride (CPVC) bearings. In this embodiment the beam 12 is shown as an elongated box beam, but could instead be an elongated flange-type beam, for example, without departing from the scope of the invention. The upper bracket 58a is attached to the top surface 12a of the beam 12, by bolts, or by welding not shown in the drawings. The lower bracket 58b is attached to the bottom surface 12b of the beam 12, by bolts or welding, not shown in the drawings. The two-sided lever 52 at the third pivot point ‘C’, which is at the center of rotation of the two-sided lever 52, is positioned equidistant and midway between the two rotating insulators 13a, 13b, i.e., midway between ‘L1’ and ‘L2’, but offset to one side away from the beam 12 as can be seen in FIGS. 2 and 3. The offset is determined by points ‘A’, ‘B’, ‘C’, ‘D’ and ‘E’ being in a straight line, as shown in FIG. 2, in the electrically closed switch position. The rotating shaft member pivot 54 is connected perpendicularly to the two-sided lever 52 at the third pivot point ‘C’ as shown in FIGS. 2 and 3, parallel to ‘L1’ and ‘L2’. A drive pipe lever 42 is attached to the rotating shaft member pivot 54 to which the drive pipe 16 is connected. The drive pipe 16 is operatively connected to drive pipe lever connection pivot point 44 of the drive pipe lever 42 by one of the clamp brackets 46 and a pivot bolt 50, in a similar manner as already described regarding the attachment of the first drive link 56a and the second drive link 56b to the respective clamp brackets 46.

To fully close the switch 10 the two-sided lever 52 as shown in FIG. 2 is rotated by the drive pipe 16 to the position shown so that first pivot point ‘A’, second pivot point ‘B’, third pivot point ‘C’, fourth pivot point ‘D’, and fifth pivot point ‘E’ are exactly in a straight line, which is the locked toggle position, which position locks the insulators 13a and 13b from rotating in the closed switch position. Only if the drive pipe 16 exerts a force imparted by a prime mover 17 to rotate shaft member pivot 54 counter clockwise will the locked toggle position be unlocked as the pivot points ‘A’, ‘B’, ‘C’, ‘D’, and ‘E’ are no longer in exact alignment. FIG. 3 shows the switch completely open due to the shaft 54 rotating 90 degrees and the pivot points ‘A’, ‘B’, ‘C’, ‘D’, and ‘E’ are no longer in exact alignment.

With the present invention, each pole of a three pole switch, not shown in the drawings, has this toggle drive locking mechanism 51 which keeps the switch blades 15a, 15b from opening a small amount and thereby prevents contact arcing during short circuit duty or seismic duty which delivers forces to move the switch blades open. Thus, any force that the switch blades 15a, 15b are subjected to, due to a seismic, short circuit magnetic conditions or other environmental condition will not translate that force back to the drive pipe or interphase pipe between phases, because of the toggle lock mechanism 51 in the closed switch position, which essentially permits no torque or very little torque about the connection pivot point ‘C’. The present invention has significant implications for high voltage center break switches that have longer and heavier blades that impart a greater force to operate same. The force from the blades would be contained to the pole unit of each phase.

### LIST OF REFERENCE NUMERALS

10 center break disconnect switch
12 elongated longitudinal base member or beam
12a top surface of beam 12
12b bottom surface of beam 12
13a first post-type rotatable cylindrically shaped insulator
13b second post-type rotatable cylindrically shaped insulator
14 switch blade assembly
15a first rotatable switch blade
15b second rotatable switch blade
16 drive pipe
17 prime mover
18a top of insulator 13a
18b top of insulator 13b
20a first line terminal stationary connection
20b second line terminal stationary connection
22a proximal end of blade 15a
22b distal end of blade 15a
24a proximal end of blade 15b
24b distal end of blade 15b
26 blade tip
27 ice shield
28 break-jaw assembly
29 corona ring
30a first pivot hinge assembly
30b second pivot hinge assembly
32 prior art single link
34a first opposite end of link 32
34b second opposite end of link 32
36a first lever
36b second lever
38a first connection point
38b second connection point
40a bottom of insulator 13a
40b top of insulator 13b
42 drive pipe lever
44 drive pipe lever connection pivot point
46 clamp bracket
50 bolt
51 toggle locking drive mechanism or assembly
52 two-sided lever
54 center rotating shaft member
56a first drive link
56b second drive link
58a upper bracket
58b lower bracket
60a upper bearing
60b lower bearing
‘L1’ longitudinal axis of 13a
‘L2’ longitudinal axis of 13b
‘A’ first pivot point
‘B’ second pivot point
‘C’ third pivot point
‘D’ fourth pivot point
‘E’ fifth pivot point

Of course variations from the foregoing embodiments are possible without departing from the scope of the invention.

What is claimed is:

1. A high voltage center break disconnect switch comprising:
two cylindrically-shaped insulators mounted perpendicularly in operative arrangement on an elongated longitudinal beam, both of the perpendicular cylindrically-shaped insulators being rotatable axially;
a switch blade assembly including a first rotatable switch blade at a proximal end thereof operatively mounted to a top of a first of the two rotatable perpendicular cylindrically-shaped insulators, a second rotatable switch blade at a proximal end thereof operatively mounted to a top of a second of the two rotatable perpendicular cylindrically-shaped insulators, the two rotatable switch blades in operative arrangement for electrically opening and closing the switch, the first rotatable switch blade having operatively attached thereto at a distal end thereof a blade tip, the second rotatable switch blade having operatively attached thereto at a distal end thereof a break-jaw assembly, in a closed position of the center break switch the blade tip and the break-jaw assembly operatively arranged for an electrically conductive contacting relationship;
a toggle locking drive assembly comprising:
a two-sided lever having three pivot points, the two-sided lever rotatably mounted in parallel relationship with respect to the elongated longitudinal beam in the electrically closed switch position,
the two-sided lever having a first pivot point positioned at a center of rotation of the two-sided lever and having two outer pivot points including a second pivot point operatively positioned in spaced relationship from the first pivot point on one side of the two-sided lever and a third pivot point operatively positioned in spaced relationship from the first pivot point on a second side of the two-sided lever,
the first pivot point and the second pivot point and the third pivot point arranged in collinear alignment on the two-sided lever,
a rotating shaft member operatively attached to the two-sided lever at the first pivot point and in perpendicular arrangement with respect to the two-sided lever,
a mounting bracket assembly attached to the elongated longitudinal beam in predetermined position for supporting the rotating shaft member beam midway between the first cylindrically-shaped insulator and the second cylindrically-shaped insulator, the mounting bracket assembly in operative attachment and supportive relationship with the rotating shaft member,
a drive pipe lever in operative attachment with the rotating shaft member and one end of a drive pipe,
a prime mover in operative arrangement with the other end of the drive pipe for causing an intended rotation of the two-sided lever to open and close the center break switch,
two oppositely disposed drive links including a first drive link at one end thereof in operative engagement with the two-sided lever at the second pivot point and a second drive link at one end thereof in operative engagement with the two-sided lever at the third pivot point,
the first drive link in operative engagement at the other end thereof with a first rotating insulator lever at a fourth pivot point of the first rotating insulator lever, the first rotating insulator lever operatively attached at a bottom of the first insulator,
the second drive link in operative engagement at the other end thereof with a second rotating insulator lever at a fifth pivot point of the second rotating insulator lever, the second rotating lever operatively attached at a bottom of the second insulator,
the center break switch having a toggle lock position in the electrically conductive closed position wherein the first pivot point, the second pivot point, the third pivot point, the fourth pivot point and the fifth pivot point of the toggle locking drive assembly are aligned colinearly for keeping the center break switch from opening from seismic, magnetic or other environmental forces exerted on the first rotatable switch blade and the second rotatable switch blade.

2. The high voltage center break disconnect switch of claim 1, wherein the first pivot point of the two-sided lever is operatively positioned midway between longitudinal axes of the first perpendicular cylindrically-shaped insulator and the second perpendicular cylindrically-shaped insulator.

3. The high voltage center break disconnect switch of claim 1, wherein the mounting bracket assembly includes at least two mounting brackets.

4. The high voltage center break disconnect switch of claim 3, wherein the at least two mounting brackets have bearings in supportive relationship with the rotating shaft member.

5. The high voltage center break disconnect switch of claim 4, wherein the rotating shaft member is operatively attached to the mounting bracket assembly by the bearings.

6. The high voltage center break disconnect switch of claim 1, wherein the rotating shaft member is operatively arranged in spaced relationship by the mounting bracket assembly offset to one side of the longitudinal beam.

7. The high voltage center break disconnect switch of claim 1, wherein the first drive link and the second drive link are of about equal length.

8. The high voltage center break disconnect switch of claim 1, wherein the first rotating insulator lever and the second rotating insulator lever are arranged on the same side of the longitudinal beam.

9. The high voltage center break disconnect switch of claim 1, wherein the first rotatable cylindrically-shaped insulator and the second rotatable cylindrically shaped insulator rotate in opposing directions as the center break switch operates.
